(19) United States
(12) Patent Application Publication
(10) Pub. No.: US 2018/0266604 A1
(43) Pub. Date: Sep. 20, 2018

(54) Bathroom quick coupling

(71) Applicant: CHENG CHANG YANG, CHANGHUA COUNTY (TW)

(72) Inventor: CHENG CHANG YANG, CHANGHUA COUNTY (TW)

(21) Appl. No.: 15/923,331

(22) Filed: Mar. 16, 2018

(30) Foreign Application Priority Data
Mar. 20, 2017 (TW) 106109158

(51) Int. Cl. F16L 37/092; F16L 37/091

(52) U.S. Cl. CPC F16L 37/0925; F16L 37/091

(57) ABSTRACT

A bathroom quick coupling includes a main body and a positioning clamp. One end of the main body is recessed to form a hollow room and an opening. The hollow room has a thin section and an expanded section. An inner diameter of the expanded section is greater than an inner diameter of the thin section. The expanded section is connected to a side of the thin section distant from the opening. The positioning clamp is in the hollow room and has a base in ring shaped. A plurality of clamping blocks is extending from one side of the base. The clamping blocks surround the base and are arranged spacedly with each other for engaging with and positioned with the external pipe. Each of the clamping blocks is slightly deformable within a gap between adjacent clamping blocks, and the clamping blocks are correspondingly extending to the expanded section.

### BACKGROUND OF THE INVENTION

### Field of the Invention

The present invention relates to a coupling structure, in particular to a bathroom quick coupling.

### Description of the Prior Art

When running water is provided for a bathroom or a restroom, the running water should be connected to a facet for controlling the turn-on and turn-off of the water and related pipes before being used. As shown in FIG. 4, a conventional coupling for connecting adjacent pipes 51, 52 is provided and the coupling includes a packing piece 61 and a nut 62, the pipe 51 has a threaded portion 511 and a tapered section 512 near the opening of the pipe 51 in which the inner diameter of the tapered section 512 gradually decreases in a direction opposite to the opening of the pipe 51. The packing piece 61 is fitted over the pipe 52 and one end of the packing piece 61 has a guiding section 611 corresponding to the profile of the tapered section 512. When the nut 62 is threaded with the threaded section 511 of the pipe 51, the nut 62 pushes the guiding section 611 of the packing piece 61 to abut against the tapered section 512, so that the nut 62 packs the packing piece 61 to engage with and position with the pipe 52, and the two adjacent pipes 51, 52 can be connected with each other.

However, in the conventional, two components, that is the packing piece 61 and the nut 62 are used, and a user has to use tools such as pliers during the operation. Consequently, the conventional coupling has many components and the assembling of the conventional coupling with the pipes is complicated.

### SUMMARY OF THE INVENTION

One object of the present invention is to provide a bathroom quick coupling in which a flexible positioning clamp is used to engage with a pipe to be connected without other components for the positioning. Therefore, the coupling has fewer components and is easy to be operated.

In view of these, a bathroom quick coupling is provided. In one embodiment, the bathroom quick coupling comprises a main body and a positioning clamp. One end of the main body has a connecting end for connecting to an external pipe. A hollow room is recessed from the connecting end to form an opening. The hollow room has a thin section and an expanded section. An inner diameter of the expanded section is greater than an inner diameter of the thin section. The expanded section is connected to a first side of the thin section distant from the opening. The positioning clamp has a base in ring shaped. A plurality of clamping blocks is extending from one side of the base. The clamping blocks surround the base and are arranged spacedly with each other for engaging with and positioned with the external pipe. Each of the clamping blocks is slightly deformable within a gap between adjacent clamping blocks. The positioning clamp is in the hollow room, and the clamping blocks are correspondingly extending to the expanded section.

In one embodiment, the inner diameter of the expanded section gradually increases in a direction opposite to the opening.

In one embodiment, a second side of the thin section near the opening is connected to a guiding section, and an inner diameter of the guiding section gradually increases in a direction toward the opening.

In one embodiment, a reverse-tooth portion is protruding from an inner side of each of the clamping blocks of the positioning clamp.

In one embodiment, a protruding portion is on an outer side of each of the clamping blocks of the positioning clamp, and an outer diameter of the positioning clamp is a distance between outer peripheries of the protruding portions of two opposite clamping blocks, and the outer diameter of the positioning clamp is greater than the inner diameter of the thin section.

In one embodiment, the hollow room has at least one annular groove, and a sealing ring is assembled in each of the at least one sealing ring.

### BRIEF DESCRIPTION OF THE DRAWINGS

FIG. 1 illustrates an exploded view of a bathroom quick coupling according to an embodiment of the present invention;

FIG. 2 illustrates a sectional view of the bathroom quick coupling;

FIG. 3 illustrates an operational view of the bathroom quick coupling;

FIG. 4 illustrates a sectional view of a conventional coupling structure.

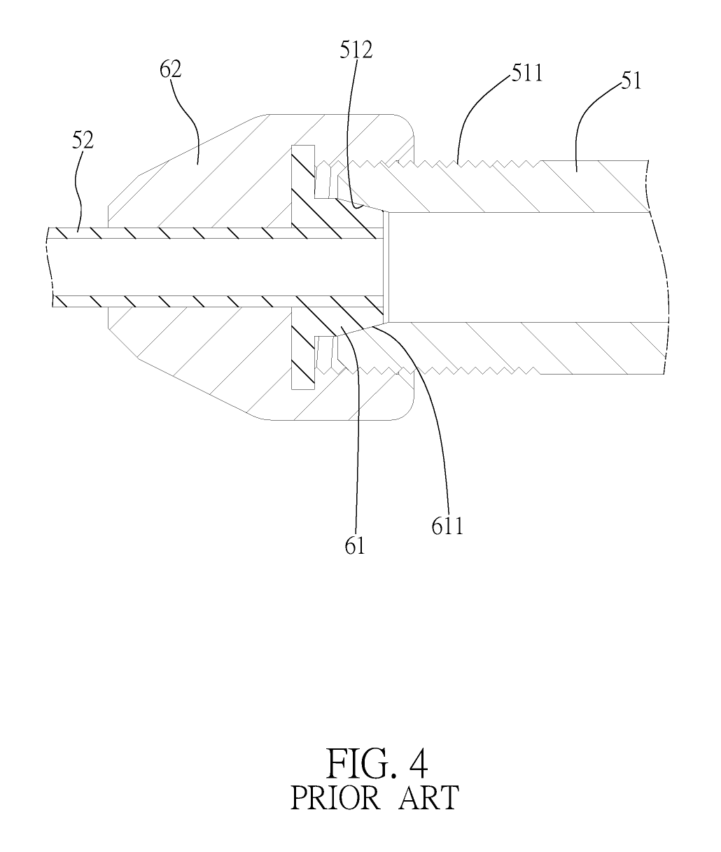

### DETAIL DESCRIPTION OF THE PREFERRED EMBODIMENTS

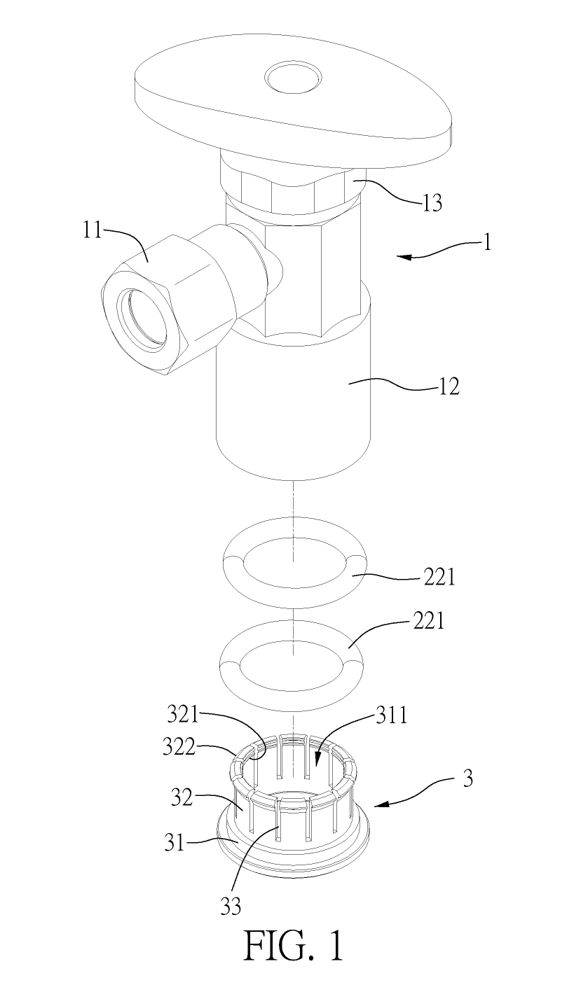

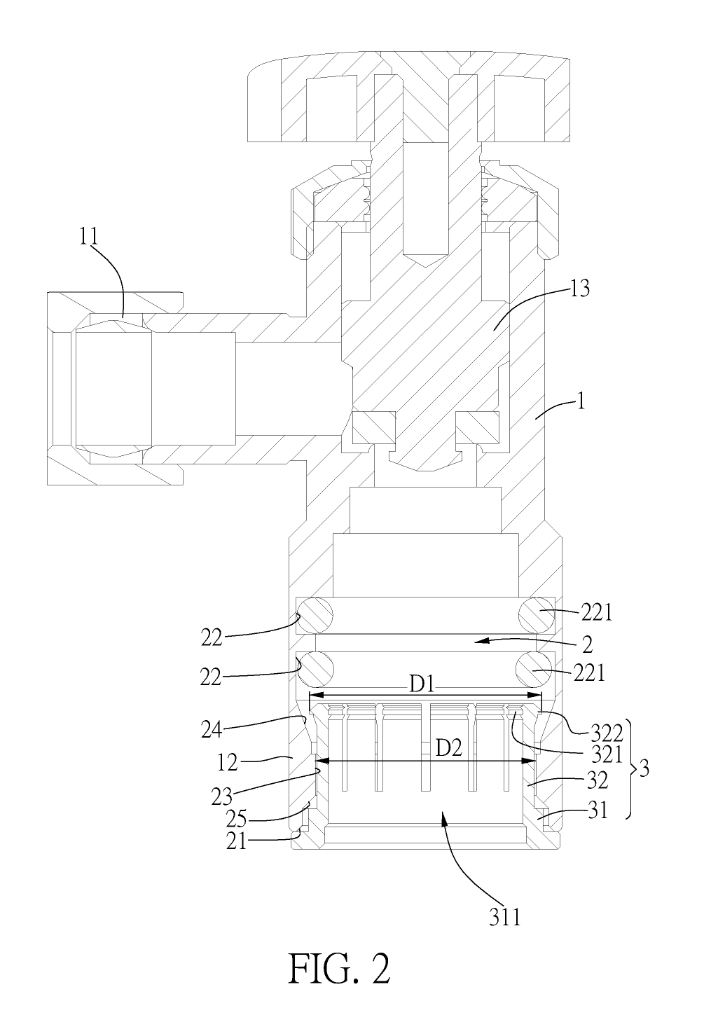

Please refer to FIGS. 1 and 2, illustrating a bathroom quick coupling according to an embodiment of the present invention. The bathroom quick coupling comprises a main body 1 in tubular shaped, the main body 1 has a water source end 11 for connecting to running water and a connecting end 12 for connecting to an external pipe. A valve 13 is between the water source end 11 and the connecting end 12 of the main body 1 for controlling the water stream.

Moreover, a hollow room 2 is recessed from the connecting end 12 of the main body 1 to form an opening 21. The hollow room 2 has at least one annular groove 22, and a sealing ring 221 is assembled in each of the at least one sealing ring 22. Hence, when the external pipe is inserted into the hollow room 2, the external pipe is enclosed by the sealing ring 221 to perform sealing. A portion of the hollow room 2 near the opening 21 has a thin section 23, and the hollow room 2 has an expanded section 24, the expanded section 24 is connected to a first side of the thin section 23 distant from the opening 21, and an inner diameter of the expanded section 24 is greater than an inner diameter of the thin section 23. The inner diameter of the expanded section 24 gradually increases in a direction opposite to the opening 21. Furthermore, a second side of the thin section 23 near the opening 21 is connected to the guiding section 25, and an inner diameter of the guiding section 25 gradually increases in a direction toward the opening 21.

On the other hand, the hollow room 2 has a positioning clamp 3 for positioning with the external pipe. The positioning clamp 3 has a base 31 in ring shaped to surround a channel 311. A plurality of clamping blocks 32 is extending from one side of the base 31. The clamping blocks 32 surround the channel 311 of the base 31 and are arranged spacedly with each other by gaps 33. Each of the clamping blocks 32 is are slightly deformable within the gap 33 between adjacent clamping blocks 32. A reverse-tooth portion 321 is protruding from an inner side of each of the clamping blocks 32 for stably engaging with the external pipe, and a protruding portion 322 is on an outer side of each of the clamping blocks 32. An outer diameter D1 of the positioning clamp 3 is a distance between outer peripheries of the protruding portions 322 of two opposite clamping blocks 32, and the outer diameter D1 of the positioning clamp 3 is greater than the inner diameter D2 of the thin section 23.

The positioning clamp 3 is engaged in the hollow room 2 from the opening 21. In detail, in the operation, since the outer diameter D1 of the positioning clamp 3 is greater than the inner diameter D2 of the thin section 23, the protruding portions 322 of the clamping blocks 32 are firstly put on the guiding section 25. Next, during placing the positioning clamp 3 in the hollow room 2, the clamping blocks 32 are guided by the guiding section 25 so as to come close to each other, thus the outer diameter D1 of the positioning clamp 3 is temporarily reduced to allow the positioning clamp 3 to enter into the thin section 23. Next, after the positioning clamp 3 passes through the thin section 23 and enters into the expanded section 24, the positioning clamp 3 is no more compressed by the thin section 23 and thus the clamping blocks 32 are resiliently recovered to the original positions. At this moment, since the outer diameter D1 of the positioning clamp 3 is again greater than the inner diameter D2 of the thin section 23, the positioning clamp 3 is engaged in the hollow room 2.

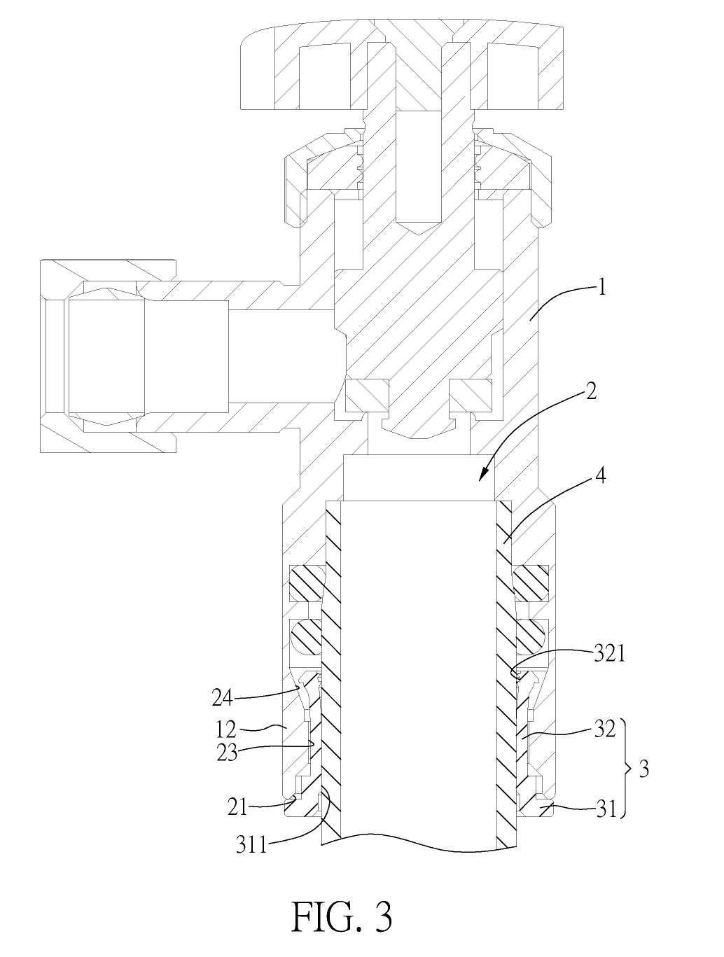

Accordingly, when an external pipe is connected to the bathroom quick coupling according to the embodiment, as shown in FIG. 3, the external pipe 4 is inserted into the hollow room 2 from the opening 21 and through the channel 311 of the base 31 of the positioning clamp 3. Then, the clamping blocks 32 are expanded outwardly in the expanded section 24 by the external pipe 4, and the external pipe 4 is clamped by the resilient force of the clamping blocks 32, so that the external pipe 4 is positioned. Furthermore, the reverse-tooth portions 321 of the clamping blocks 32 can closely engage with the external pipe 4 to generate a greater friction force. Therefore, the external pipe 4 can be stably connected to the connecting end 12 of the main body 1.

As above, the invention has fewer components, as compared with the conventional. Moreover, when a user tends to connect an external pipe 4 with the coupling, the external pipe 4 is inserted into the connecting end 12 and the external pipe 4 can be automatically engaged with the positioning clamp 3. Therefore, the user can perform the operation in an easy and convenient manner, facilitating the assembling of the bathroom components.

What is claimed is:

1. A bathroom quick coupling, comprising:
a main body, one end thereof having a connecting end for connecting to an external pipe; a hollow room recessed from the connecting end to form an opening, the hollow room having a thin section and an expanded section, an inner diameter of the expanded section being greater than an inner diameter of the thin section, the expanded section connected to a first side of the thin section distant from the opening; and
a positioning clamp having a base in ring shaped, a plurality of clamping blocks extending from one side of the base, the clamping blocks surrounding the base and arranged spacedly with each other for engaging with and positioned with the external pipe, wherein each of the clamping blocks is slightly deformable within a gap between adjacent clamping blocks; the positioning clamp being in the hollow room, and the clamping blocks correspondingly extending to the expanded section.

2. The bathroom quick coupling according to claim 1, wherein the inner diameter of the expanded section gradually increases in a direction opposite to the opening.

3. The bathroom quick coupling according to claim 1, wherein a second side of the thin section near the opening is connected to a guiding section, and an inner diameter of the guiding section gradually increases in a direction toward the opening.

4. The bathroom quick coupling according to claim 1, wherein a reverse-tooth portion is protruding from an inner side of each of the clamping blocks of the positioning clamp.

5. The bathroom quick coupling according to claim 1, wherein a protruding portion is on an outer side of each of the clamping blocks of the positioning clamp, and an outer diameter of the positioning clamp is a distance between outer peripheries of the protruding portions of two opposite clamping blocks, and the outer diameter of the positioning clamp is greater than the inner diameter of the thin section.

6. The bathroom quick coupling according to claim 1, wherein the hollow room has at least one annular groove, and a sealing ring is assembled in each of the at least one sealing ring.
